(19) United States
(12) Patent Application Publication
(10) Pub. No.: US 2019/0389042 A1
(43) Pub. Date: Dec. 26, 2019

(54) Suction Cover Gland Tool

(71) Applicant: WD Pumpco LLC, Zanesville, OH (US)

(72) Inventors: Terry Andrew Goss, Zanesville, OH (US); Douglas James Meredith, Kimbolton, OH (US)

(21) Appl. No.: 16/014,679

(22) Filed: Jun. 21, 2018

(51) Int. Cl. B25B 27/02; F04B 53/22; B25G 1/10

(52) U.S. Cl. CPC B25B 27/02; E21B 43/26; B25G 1/102; F04B 53/22

(57) ABSTRACT

A suction cover gland tool includes a handle having a first end and a second end, opposite the first end, the handle having a through bore extending from the first end of the handle to the second end of the handle. The tool also includes a first cap disposed on the first end of the handle. The tool also includes a second cap disposed on the second end of the handle. The tool also includes a slide bar at least partially disposed within the through bore of the handle and adapted to slidingly mate with the second cap. The tool also includes an engaging member disposed on an end of the slide bar, the engaging member being adapted to mate with a receiving portion of a suction cover gland.

### TECHNICAL FIELD

This disclosure relates to the field of oil and gas extraction, and, in particular, to suction cover gland removal tools associated therewith.

### BACKGROUND

Pumps used in oil and gas extraction, such as with hydraulic fracturing, are high-powered pumps that typically include two primary mechanisms, a power end (e.g., power end unit) and a fluid end (e.g., a fluid end unit). The power end unit produces or otherwise outputs mechanical energy that operates the fluid end unit, which in turn pumps liquid at high pressures (e.g., up to approximately 15,000 psi or more) and/or flow rates (e.g., up to approximately 100 barrels per minute or more) depending on the application.

Such pumps typically require routine maintenance. For example, the fluid end unit may include a plurality of components, such as valves, seals, gaskets, mechanical components, other suitable components, or a combination thereof. The plurality of components may be disposed within an interior portion of the fluid end unit. During operation (e.g., while the fluid end unit is in use at an oil and gas extraction site), a technician may access these components (e.g., several times throughout a typical operation cycle) and replace one or more components of the fluid end unit, perform maintenance on the one or more components of the fluid end unit, perform other suitable maintenance on the fluid end unit, or a combination thereof. In order to access these components, the technician typically removes a suction cover gland from the fluid end unit using a suction cover gland removal tool.

### SUMMARY

Disclosed herein are implementations of features, elements, implementations, and embodiments of suction cover gland removal tools.

An aspect of the disclosed embodiments is a suction cover gland tool. The suction cover gland tool includes a handle having a first end and a second end, opposite the first end, the handle having a through bore extending from the first end of the handle to the second end of the handle. The tool also includes a first cap disposed on the first end of the handle. The tool also includes a second cap disposed on the second end of the handle. The tool also includes a slide bar at least partially disposed within the through bore of the handle and adapted to slidingly mate with the second cap. The tool also includes an engaging member disposed on an end of the slide bar, the engaging member being adapted to mate with a receiving portion of a suction cover gland.

Another aspect of the disclosed embodiments is an assembly for engaging a suction cover gland. The assembly includes a handle having a first end and a second end, opposite the first end, the handle having a through bore extending from the first end of the handle to the second end of the handle. The assembly also includes a first cap that includes a first portion disposed proximate the first end of the handle and a second portion disposed opposite the first portion, the second portion of the first cap having a diameter that is larger than a diameter of the first portion of the first cap. The assembly also includes a second cap that includes a first portion disposed proximate the second end of the handle and a second portion disposed opposite the first portion, the second portion of the second cap having a diameter that is larger than a diameter of the first portion of the second cap. The assembly also includes a slide bar at least partially disposed within the through bore of the handle and adapted to slidingly mate with the second cap. The assembly also includes an engaging member disposed on an end of the slide bar, the engaging member being adapted to mate with a receiving portion of the suction cover gland.

Another aspect of the disclosed embodiments is an assembly for engaging a suction cover gland. The assembly includes a handle having a first end and a second end, opposite the first end, the handle having a through bore extending from the first end of the handle to the second end of the handle. The assembly also includes a first cap that includes a first portion disposed proximate the first end of the handle and a second portion disposed opposite the first portion, the second portion of the first cap having a diameter that is larger than a diameter of the first portion of the first cap. The assembly also includes a second cap that includes a first portion disposed proximate the second end of the handle and a second portion disposed opposite the first portion, the second portion of the second cap having a diameter that is larger than a diameter of the first portion of the second cap. The assembly also includes a mating portion disposed on the second portion of the second cap, the mating portion having a hexagonal profile. The assembly also includes a slide bar that is extendable between a first and second position and that is at least partially disposed within the through bore of the handle and adapted to slidingly mate the mating portion of the second cap. The assembly also includes an engaging member disposed on an end of the slide bar, the engaging member being adapted to mate with a receiving portion of the suction cover gland.

Variations in these and other aspects, features, elements, implementations, and embodiments of the methods, apparatus, procedures, and algorithms disclosed herein are described in further detail hereafter.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 generally illustrates a perspective view of a fluid end unit according to the principles of the present disclosure.

FIG. 2 generally illustrates a retracted view of a suction cover gland removal tool according to the principles of the present disclosure.

FIG. 3 generally illustrates an extended view of the suction cover gland removal tool of FIG. 2.

FIG. 4 generally illustrates a component view of the suction cover gland removal tool of FIG. 2.

FIG. 5 generally illustrates a top view of a front cap of a suction cover gland removal tool according to the principles of the present disclosure.

FIG. 6 generally illustrates a perspective view of an engaging member of a suction cover gland removal tool according to the principles of the present disclosure.

### DETAILED DESCRIPTION

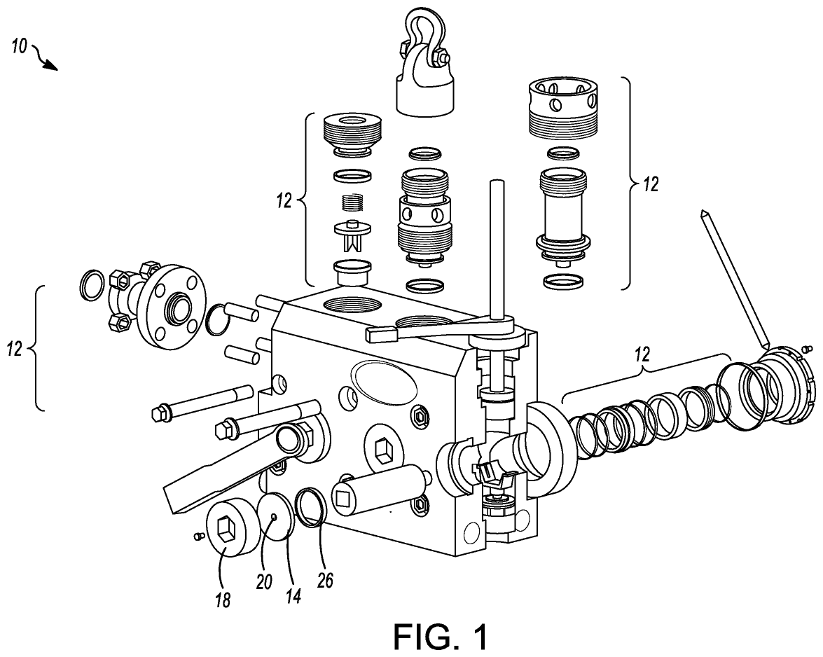

As described above, pumps used in oil and gas extraction, such as with hydraulic fracturing, are high-powered pumps that typically include two primary mechanisms, the power end unit and the fluid end unit, such as the fluid end unit 10 generally illustrated in FIG. 1. The power end unit produces or otherwise outputs mechanical energy that operates the fluid end unit 10, which in turn pumps liquid at high pressures (e.g., up to approximately 15,000 psi or more) and/or flow rates (e.g., up to approximately 100 barrels per minute or more) depending on the application.

The fluid end unit 10 may comprise a steel or other suitable material, or combination of materials. During operation of the fluid end unit 10 (e.g., while the fluid end unit 10 is in use at an oil and gas extraction site), routine maintenance may be performed on one or more of a plurality of components 12 of the fluid end unit 10. The plurality of components 12 may include valves, seals, gaskets, mechanical components, other suitable components, or a combination thereof. The components 12 are disposed within the interior portion of the fluid end unit 10, which may make access to the components 12, especially during operation of the fluid end unit 10, difficult.

For example, while the fluid end unit 10 is in use at the oil and gas extraction site, a technician may access the components 12 (e.g., several times throughout a typical operation cycle) by removing a suction cover gland 14 from a portion of the fluid end unit 10. The suction cover gland 14 may comprise a metal material with a rubber or polyurethane coating, however, the suction cover gland 14 may comprise other suitable materials. The technician may remove the suction cover gland 14 in order to replace one or more of the components 12, perform maintenance on the one or more of the components 12, perform other suitable maintenance on the fluid end unit 10, or a combination thereof.

As is generally illustrated in FIG. 1, the suction cover gland 14 is adapted to seal an aperture disposed in a side of the fluid end unit 10. In some embodiments, a seal 16 may be inserted into the aperture in order to form a fluid tight seal at the aperture when the suction cover gland 14 is inserted into the aperture in the side of the fluid end unit 10. The seal 16 may comprise any suitable seal. The suction cover gland 14 is inserted into the aperture, such that the seal 16 is disposed around an external circumference of a portion of the suction cover gland 14. The suction cover gland 14 is adapted to seal the aperture, such that, when the suction cover gland 14 is inserted into the aperture of the fluid end unit 10, at least a portion of the suction cover gland 14 prevents fluid from exiting the fluid end unit 10 through the aperture of the fluid end unit 10.

The aperture of the fluid end unit 10 may include a plurality of internal threads that are adapted to mate with external threads of a suction cover nut 18. The suction cover nut 18 is inserted into the aperture of the fluid end unit 10 after the suction cover gland 14 is inserted into the aperture of the fluid end unit 10. The suction cover nut 18 may be rotated by a suitable tool in order to thread the suction cover nut 18 into the aperture of the fluid end unit 10.

As described, the technician may remove the suction cover gland 14 in order to access the components 12 disposed within the interior portion of the fluid end unit 10 (e.g., after removing the suction cover nut 18). The technician may utilize a typical suction cover gland removal tool. Such tools typically attach or couple to a portion of the suction cover gland 14. The technician may then apply a relatively large retraction force on the suction cover gland 14 using the suction cover gland removal tool. Further, after the technician has performed maintenance on the fluid end unit 10 and/or the components 12, the technician may replace or insert the suction cover gland 14 by apply a relatively large insertion force on the suction cover gland 14 using the suction cover gland removal tool. Applying retraction and/or insertion forces on the suction cover gland 14 using the suction cover gland removal tool may cause the technician's hand to slip on the suction cover gland removal tool, which may result in injury to the technician. Accordingly, a suction cover gland removal too, according to the principles of the present disclosure, that is adapted to limit and/or prevent injury, such as pinching, cutting, gouging, or other injury, to the technician while using the suction cover gland removal tool, may be desirable.

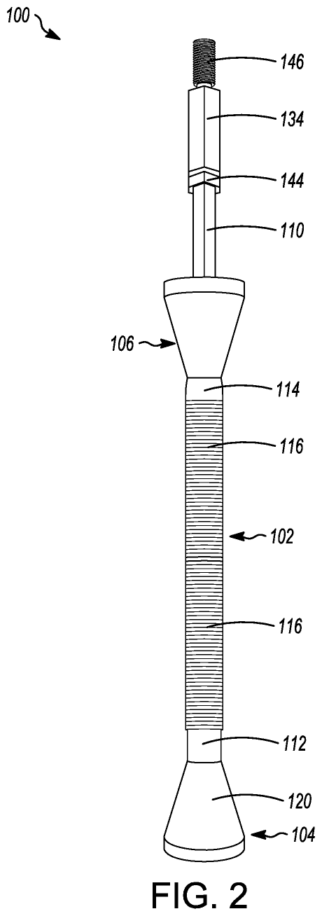

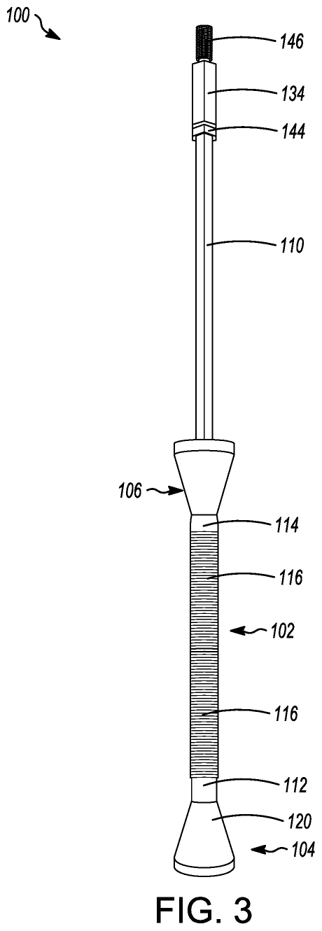

FIGS. 2 and 3 generally illustrate a suction cover gland removal tool 100 according to the principles of the present disclosure. The suction cover gland removal tool 100 is adapted to remove and/or replace the suction cover gland 14 from the fluid end unit 10. The suction cover gland removal tool 100 may comprise steel or other suitable material. The suction cover gland removal tool 100 includes a handle 102, a first cap 104, a second cap 106, and a slide bar 110.

In some embodiments, the handle 102 includes a generally cylindrical profile or other suitable profile. The handle 102 may include a plurality of anti-slip members 116 disposed circumferentially around an exterior portion of the handle 102. The anti-slip members 116 may include knurled grooves, threads, or other suitable anti-slip members. The anti-slip members 116 may be engaged by the technician (e.g., by the technician gripping the handle 102 at a portion of the handle 102 that includes the anti-slip members 116). The anti-slip members 116 are adapted to provide or increase friction on the handle 102, such that, when the technician engages the anti-slip members 116, the anti-slip members 116 limit or prevent the technicians hand from slipping on the handle 102.

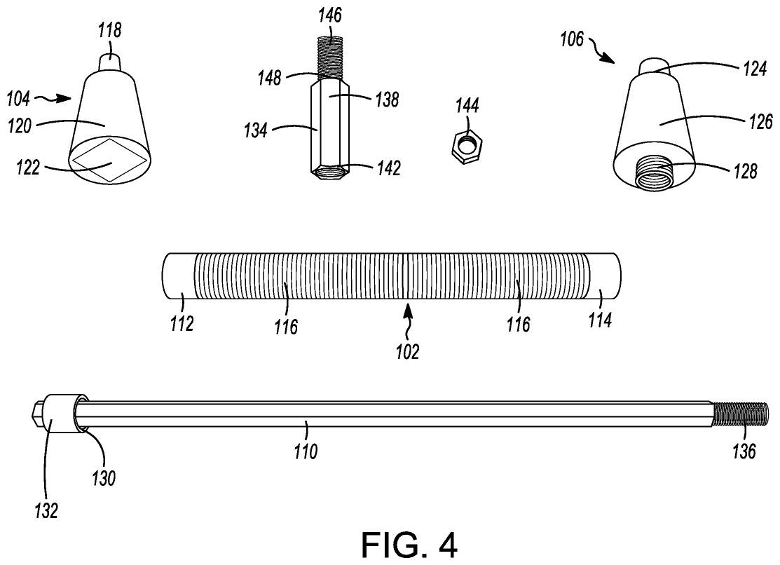

The handle 102 includes a first end 112 and a second end 114. The second end 114 is disposed on the handle 102 opposite the first end 112. The handle 102 includes a bore extending through a central portion of the handle 102 from the first end 112 to the second end 114. The first cap 104 is selectively attachable to the first end 112 of the handle 102. For example, and as is generally illustrated in FIG. 4, the first cap 104 includes an attachment portion 118. The attachment portion 118 may include a plurality of threads circumferentially disposed around the attachment portion 118. The threads of the attachment portion 118 are adapted to mate with corresponding threads disposed on an internal surface of the first end 112 of the handle 102. In some embodiments, the attachment portion 118 may be welded to the interior portion of the first end 112 of the handle 102, or attached to the first end 112 of the handle 102 using other suitable techniques than those described herein.

The first cap 104 includes a body 120 that extends from the attachment portion 118. The body 120 may include a generally conical profile, or other suitable profile. When the first cap 104 is attached to the first end 112 of the handle 102, the first cap 104 may provide a gripping point for the technician to grip the suction cover gland removal tool 100. For example, as described above, in order to remove the suction cover gland 14 from the fluid end unit 10, the technician may apply a retraction force on the suction cover gland removal tool 100 (e.g., the technician may pull back on the suction cover gland removal tool 100 while the suction cover gland removal tool 100 is attached to the suction cover gland 14, as will be described). The technician may grip the first cap 104 and/or a portion of the handle 102 when applying the retraction force.

In some embodiments, the first cap 104 is a weight cap. For example, additional material may be added to the first cap 104 to increase an overall weight of the first cap 104. By increasing the overall weight of the first cap 104, the first cap 104 may act to increase the retraction force applied to the suction cover gland 14 when the technician applies the retraction force on the suction cover gland removal tool 100.

Additionally, or alternatively, the first cap 104 includes an end portion 122 disposed on an end of the first cap 104 opposite the attachment portion 118. The end portion 122 includes a profile that corresponds to the profile of the body 120. For example, the end portion 122 includes a generally circular profile corresponding to the generally conical profile of the body 120. The end portion 122 includes a diameter that is larger than a diameter of a portion of the body 120 proximate the attachment portion 118.

The end portion 122 includes a surface that includes a flat profile, convex profile, concave profile, or other suitable profile. The end portion 122 may be used as a striking surface. For example, as described above, the technician may apply a relatively large insertion force on the suction cover gland removal tool 100 in order to insert the suction cover gland 14 into the fluid end unit 10. In order to apply the insertion force, the technician may using a driving tool, such as a hammer or other suitable tool, to drive the suction cover gland 14 into the fluid end unit 10. For example, the technician may hit or strike the end portion 122 of the first cap 104 with the driving tool.

The second cap 106 is selectively attachable to the second end 114 of the handle 102. For example, and as is generally illustrated in FIG. 4, the second cap 106 includes an attachment portion 124. The attachment portion 124 may include a plurality of threads circumferentially disposed around the attachment portion 124. The threads of the attachment portion 124 are adapted to mate with corresponding threads disposed on an internal surface of the second end 114 of the handle 102. In some embodiments, the attachment portion 124 may be welded to the interior portion of the second end 114 of the handle 102, or attached to the second end 114 of the handle 102 using other suitable techniques than those described herein.

The second cap 106 includes a body 126 that extends from the attachment portion 124. The body 126 may include a generally conical profile, or other suitable profile. When the second cap 106 is attached to the second end 114 of the handle 102, the second cap 106 may provide a gripping point for the technician to grip the suction cover gland removal tool 100. For example, as described above, in order to insert the suction cover gland 14 into the fluid end unit 10, the technician may apply an insertion force on the suction cover gland removal tool 100 (e.g., the technician may push or drive the suction cover gland removal tool 100 toward the suction cover gland 14, while the suction cover gland removal tool 100 is attached to the suction cover gland 14, as will be described). The technician may grip the second cap 106 and/or a portion of the handle 102 when applying the insertion force.

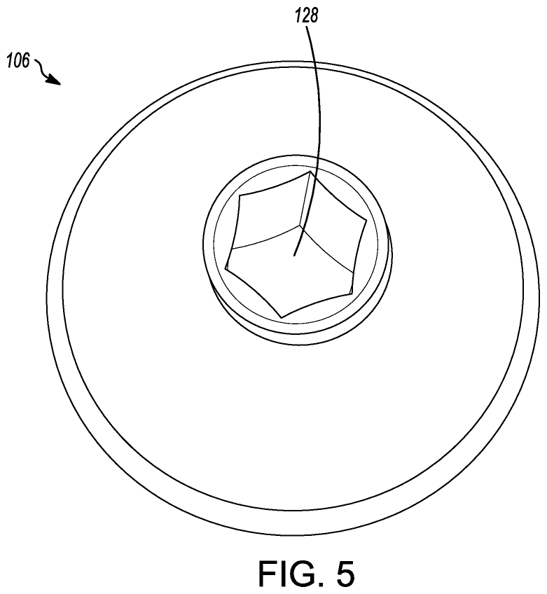

The second cap 106 is adapted to slidingly mate with or engage at least a portion of the slide bar 110. For example, the slide bar 110 includes a profile. The profile of the slide bar 110 may comprise an octagonal profile, a hexagonal profile, a triangular profile, or other suitable profile. As is generally illustrated in FIG. 5, the second cap 106 includes a mating portion 128. The mating portion 128 is disposed on an end of the second cap 106 that is opposite the attachment portion 124. The mating portion 128 includes an inner profile that is adapted to correspond to the profile of the slide bar 110. The second cap 106 includes a bore that extends from the attachment portion 124 to the mating portion 128. In some embodiments, the body 126 may include a first diameter disposed proximate the mating portion 128 that is larger than a second diameter of the body 126 disposed proximate the attachment portion 124.

As described above, the second cap 106 is attachable to the second end 114 of the handle 102. Prior to the second cap 106 being attached to the second end 114 of the handle 102, the slide bar 110 is inserted into the bore of the handle 102 that extends from the first end 112 to the second end 114. The second cap 106 is slid over the slide bar 110 such that the attachment portion 118 engages the second end 114 of the handle 102. The slide bar 110 passes through the bore of the second cap 106. The mating portion 128 mates with or engages the slide bar 110, such that the mating portion 128 limits or eliminates axial or rotational movement of the slide bar 110 while the suction cover gland removal tool 100 is in use.

The slide bar 110 extends from the second cap 106 away from the handle 102. The slide bar 110 is extendable between a first or retracted position, as is illustrated in FIG. 2, and a second or extended position, as is illustrated in FIG. 3. For example, as described, the technician applies an insertion force on the suction cover gland 14 using the suction cover gland removal tool 100 to insert the suction cover gland 14 into the fluid end unit 10. The technician may drive the handle 102 toward the suction cover gland 14 when the technician applies the insertion force. When the handle 102 is driven toward the suction cover gland 14, the slide bar 110 retracts to the retracted position. When the slide bar 110 is in the retracted position, a first end 130 of the slide bar 110 engages or makes contact with a portion of the first cap 104 (e.g., a portion of the first cap 104 that is disposed within the handle 102). This may increase the rigidity of the suction cover gland removal tool 100, which may allow the insertion force to be transfer to the suction cover gland 14.

Conversely, as described, the technician applies a retraction force on the suction cover gland 14 using the suction cover gland removal tool 100 to remove the suction cover gland 14 from the fluid end unit 10. The technician may pull back on the handle 102 when the suction cover gland removal tool 100 is attached to the suction cover gland 14, which extends the slide bar 110 to the extended position. The technician may repeatedly push the handle 102 toward the suction cover gland 14 and pull the handle 102 away from the suction cover gland 14 (e.g., retracting and extending the slide bar 110) in order to remove the suction cover gland 14 form the fluid end unit 10.

In some embodiments, the slide bar 110 includes a stop 132. The stop is disposed on the first end 130 of the slide bar 110. The stop 132 includes a diameter that is larger than a diameter of the mating portion 128 of the second cap 106, such that, when the slide bar 110 is extended to the extended position, the stop 132 prevents the first end 130 of the slide bar 110 from passing through the second cap 106. In some embodiments, the stop 132 includes a profile that is different from the profile of the mating portion 128. For example, the stop 132 may include a generally cylindrical profile while the mating portion 128 includes a generally hexagonal profile.

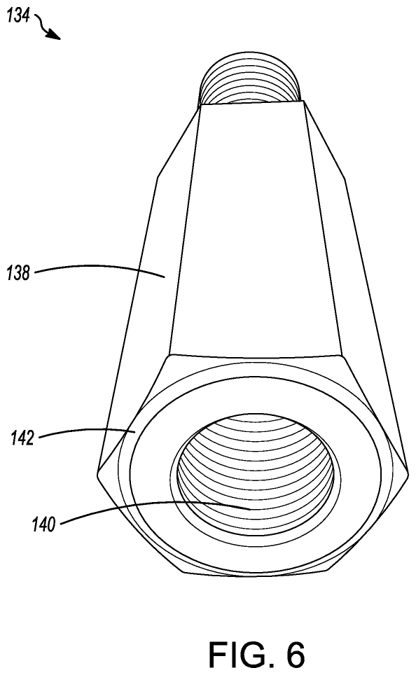

In some embodiments, the suction cover gland removal tool 100 includes an engaging member 134. The engaging member 134 is disposed on a second end 136 of the slide bar 110. The second end 136 is disposed on the slide bar 110 opposite the first end 130. The second end 136 is adapted to mate with the engagement member 134. For example, the engaging member 134 includes a first portion 138. As is generally illustrated in FIG. 6, the first portion 138 includes a bore 140 disposed on a first end 142 of the first portion 138. The bore 140 includes a diameter that is slightly larger than a diameter of the second end 136 of the slide bar 110, such that the bore 140 is adapted to receive the second end 136.

In some embodiments, the engaging member 134 may be welded to the second end 136. In some embodiments the engaging member 134 may be selectively attachable to and removable from the second end 136. For example, the bore 140 includes a plurality of threads circumferentially disposed around an interior surface of the bore 140. The threads of the bore 140 are adapted to mate with a plurality of threads that are circumferentially disposed around a portion of the second end 136. The engaging member 134 may be selectively attached to or removed from the slide bar 110 by mating the threads of the bore 140 with the threads of the second end 136. The engaging member 134 may be selectively attachable to and removable from the slide bar 110 using other suitable techniques than those described herein. For example, the engagement member 134 may be press fit onto the second end 136, the engagement member 134 may snap on to the second end 136, or other suitable techniques. In some embodiments, the suction cover gland removal tool 100 includes a nut 144. The nut 144 may be threaded on or otherwise attached to the second end 136 of the slide bar 110 before the engaging member 134. The nut 144 may prevent the engaging member 134 from being locked on to the second end 136 and/or the nut 144 may act as a spacer when attaching the engaging member 134 to the second end 136.

The engaging member 134 includes an attachment portion 146. The attachment portion 146 extends from a second end 148 of the first portion 138, away from the first end 142. The attachment portion 146 includes a plurality of threads circumferentially disposed around an outer profile of the attachment portion 146. The threads of the attachment portion 146 are adapted to mate with a portion of the suction cover gland 14. For example, the suction cover gland 14 includes a receiving portion 20 disposed at a substantially center portion of the suction cover gland 14. The receiving portion 20 includes a plurality of threads circumferentially disposed around an internal surface of the receiving portion 20. The threads of the attachment portion 146 are adapted to mate with the threads of the receiving portion 20 of the suction cover gland 14. The threads of the attachment portion 146 and the threads of the receiving portion 20 of the suction cover gland 14 cooperatively operate to limit or prevent withdrawal of the suction cover gland removal tool 100 from the suction cover gland 14 when the technician applies the retraction force and/or the insertion force on the suction cover gland 14.

In some embodiments, a suction cover gland tool, according to the principles of the present disclosure includes a handle having a first end and a second end, opposite the first end, the handle having a through bore extending from the first end of the handle to the second end of the handle. The tool also includes a first cap disposed on the first end of the handle. The tool also includes a second cap disposed on the second end of the handle. The tool also includes a slide bar at least partially disposed within the through bore of the handle and adapted to slidingly mate with the second cap. The tool also includes an engaging member disposed on an end of the slide bar, the engaging member being adapted to mate with a receiving portion of a suction cover gland.

In some embodiments of the tool, the second cap includes a through bore extending a length of the second cap. In some embodiments of the tool, the second cap includes a mating portion having a profile corresponding to a profile of the slide bar. In some embodiments of the tool, the slide bar includes a hexagonal profile. In some embodiments, the tool includes a stopping member disposed on an end of the slide bar proximate the handle. In some embodiments of the tool, the stopping member is adapted to restrict extension of the slide bar. In some embodiments of the tool, the engaging member includes a threaded bore adapted to mate with a threaded portion of the end of the slide bar. In some embodiments of the tool, the engaging member includes a threaded attachment portion adapted to mate with the receiving portion of the suction cover gland. In some embodiments of the tool, the slide bar is extendable between a first position and a second position.

In some embodiments, an assembly for engaging a suction cover gland, according to the principles of the present disclosure, includes a handle having a first end and a second end, opposite the first end, the handle having a through bore extending from the first end of the handle to the second end of the handle. The assembly also includes a first cap that includes a first portion disposed proximate the first end of the handle and a second portion disposed opposite the first portion, the second portion of the first cap having a diameter that is larger than a diameter of the first portion of the first cap. The assembly also includes a second cap that includes a first portion disposed proximate the second end of the handle and a second portion disposed opposite the first portion, the second portion of the second cap having a diameter that is larger than a diameter of the first portion of the second cap. The assembly also includes a slide bar at least partially disposed within the through bore of the handle and adapted to slidingly mate with the second cap. The assembly also includes an engaging member disposed on an end of the slide bar, the engaging member being adapted to mate with a receiving portion of the suction cover gland.

In some embodiments of the assembly, the second cap includes a through bore extending a length of the second cap. In some embodiments of the assembly, the second cap includes a mating portion having a profile corresponding to a profile of the slide bar. In some embodiments of the assembly, the slide bar includes a hexagonal profile. In some embodiments, the assembly includes a stopping member disposed on an end of the slide bar proximate the handle. In some embodiments of the assembly, the stopping member is adapted to restrict extension of the slide bar. In some embodiments of the assembly, the engaging member includes a threaded bore adapted to mate with a threaded portion of the end of the slide bar. In some embodiments of the assembly, the engaging member includes a threaded attachment portion adapted to mate with the receiving portion of the suction cover gland. In some embodiments of the assembly, the slide bar is extendable between a first position and a second position.

In some embodiments, an assembly for engaging a suction cover gland, according to the principles of the present disclosure, includes a handle having a first end and a second end, opposite the first end, the handle having a through bore extending from the first end of the handle to the second end of the handle. The assembly also includes a first cap that includes a first portion disposed proximate the first end of the handle and a second portion disposed opposite the first portion, the second portion of the first cap having a diameter that is larger than a diameter of the first portion of the first cap. The assembly also includes a second cap that includes a first portion disposed proximate the second end of the handle and a second portion disposed opposite the first portion, the second portion of the second cap having a diameter that is larger than a diameter of the first portion of the second cap.

The assembly also includes a mating portion disposed on the second portion of the second cap, the mating portion having a hexagonal profile. The assembly also includes a slide bar that is extendable between a first and second position and that is at least partially disposed within the through bore of the handle and adapted to slidingly mate the mating portion of the second cap. The assembly also includes an engaging member disposed on an end of the slide bar, the engaging member being adapted to mate with a receiving portion of the suction cover gland. In some embodiments of the assembly, the slide bar includes a hexagonal profile.

As used herein, the terminology “or” is intended to mean an inclusive “or” rather than an exclusive “or”. That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A suction cover gland tool, comprising:
a handle having a first end and a second end, opposite the first end, the handle having a through bore extending from the first end of the handle to the second end of the handle;
a first cap disposed on the first end of the handle;
a second cap disposed on the second end of the handle;
a slide bar at least partially disposed within the through bore of the handle and adapted to slidingly mate with the second cap; and
an engaging member disposed on an end of the slide bar, the engaging member being adapted to mate with a receiving portion of a suction cover gland.

2. The tool of claim 1, wherein the second cap includes a through bore extending a length of the second cap.

3. The tool of claim 1, wherein the second cap includes a mating portion having a profile corresponding to a profile of the slide bar.

4. The tool of claim 1, wherein the slide bar includes a hexagonal profile.

5. The tool of claim 1, further comprising a stopping member disposed on an end of the slide bar proximate the handle.

6. The tool of claim 5, wherein the stopping member is adapted to restrict extension of the slide bar.

7. The tool of claim 1, wherein the engaging member includes a threaded bore adapted to mate with a threaded portion of the end of the slide bar.

8. The tool of claim 1, wherein the engaging member includes a threaded attachment portion adapted to mate with the receiving portion of the suction cover gland.

9. The tool of claim 1, wherein the slide bar is extendable between a first position and a second position.

10. An assembly for engaging a suction cover gland, comprising:
a handle having a first end and a second end, opposite the first end, the handle having a through bore extending from the first end of the handle to the second end of the handle;
a first cap that includes a first portion disposed proximate the first end of the handle and a second portion disposed opposite the first portion, the second portion of the first cap having a diameter that is larger than a diameter of the first portion of the first cap;
a second cap that includes a first portion disposed proximate the second end of the handle and a second portion disposed opposite the first portion, the second portion of the second cap having a diameter that is larger than a diameter of the first portion of the second cap;
a slide bar at least partially disposed within the through bore of the handle and adapted to slidingly mate with the second cap; and
an engaging member disposed on an end of the slide bar, the engaging member being adapted to mate with a receiving portion of the suction cover gland.

11. The assembly of claim 10, wherein the second cap includes a through bore extending a length of the second cap.

12. The assembly of claim 10, wherein the second cap includes a mating portion having a profile corresponding to a profile of the slide bar.

13. The assembly of claim 10, wherein the slide bar includes a hexagonal profile.

14. The assembly of claim 10, further comprising a stopping member disposed on an end of the slide bar proximate the handle.

15. The assembly of claim 14, wherein the stopping member is adapted to restrict extension of the slide bar.

16. The assembly of claim 10, wherein the engaging member includes a threaded bore adapted to mate with a threaded portion of the end of the slide bar.

17. The assembly of claim 10, wherein the engaging member includes a threaded attachment portion adapted to mate with the receiving portion of the suction cover gland.

18. The assembly of claim 10, wherein the slide bar is extendable between a first position and a second position.

19. An assembly for engaging a suction cover gland, comprising:
a handle having a first end and a second end, opposite the first end, the handle having a through bore extending from the first end of the handle to the second end of the handle;
a first cap that includes a first portion disposed proximate the first end of the handle and a second portion disposed opposite the first portion, the second portion of the first cap having a diameter that is larger than a diameter of the first portion of the first cap;
a second cap that includes a first portion disposed proximate the second end of the handle and a second portion disposed opposite the first portion, the second portion of the second cap having a diameter that is larger than a diameter of the first portion of the second cap;
a mating portion disposed on the second portion of the second cap, the mating portion having a hexagonal profile;
a slide bar that is extendable between a first and second position and that is at least partially disposed within the through bore of the handle and adapted to slidingly mate the mating portion of the second cap; and
an engaging member disposed on an end of the slide bar, the engaging member being adapted to mate with a receiving portion of the suction cover gland.

20. The assembly of claim 19, wherein the slide bar includes a hexagonal profile.
